(19) United States
(12) Patent Application Publication
(10) Pub. No.: US 2004/0245211 A1
(43) Pub. Date: Dec. 9, 2004

(54) Method for forming conducting layer onto substrate

(76) Inventors: Peter Sidney Albert Evans, Surrey (GB); David Harrison, Surrey (GB)

Correspondence Address: Intellectual Property Department, Dewitt Ross & Stevens, 8000 Excelsior Drive Suite 401, Madison, WI, 53717-1914, US

(21) Appl. No.: 10/483,933

(22) PCT Filed: Jul. 17, 2002
(86) PCT No.: PCT/GB02/03248

(30) Foreign Application Priority Data
Jul. 17, 2001 (GB) GB 0117431.7

(51) Int. Cl. H01B 13/00

(52) U.S. Cl. 216/13

(57) ABSTRACT

A process for forming a conductive layer on a substrate is disclosed which comprises the steps of providing an ink comprising a metal oxide in particulate form suspended in a mixture of a resin and an organic solvent, depositing the ink on a substrate by means of a lithographic printing process, and applying a reducing agent to the ink to reduce at least some of said metal oxide to metal. Preferably, a mixture of an alkyd and a non-alkyd resin is employed.

The present application relates to a process for forming a conductive layer on a substrate. In particular, it relates to a method of forming plating seeding layers on flexible substrates via printing processes, enabling low-cost substitutes for electrical circuitry (such as flexible electronic wiring boards) to be manufactured via printing and plating technologies.

Conventionally, silicon devices are mounted on printed circuit boards (PCB). A printed circuit board generally consists of etched copper on glass fiber laminate, tin plated and possibly carrying further layers of lacquer for protection and labeling. Many operations of cropping, drilling, etching and plating are involved in its preparation. It is not cheap, and the production processes can have significant environmental impact.

The two major environmental hazards posed by PCB manufacture are the waste effluent (which contains ferric chloride and heavy metals, especially copper), and the use of hydrocarbons in photoresist developer and stripper. Stricter pollution limits imposed by water authorities are one driving force to reduce copper in effluent. In theory, waste effluent could be eliminated by a totally additive process for copper deposition, which would also offer considerable cost savings, but a satisfactory process has not yet been developed.

Attempts to avoid the use of a circuit board as such include the use of both thick and thin film techniques, normally associated with higher cost, not lower. Resistors are formed on a ceramic substrate by depositing tracks of a suitable film, sometimes trimmed to precise values by laser etching. A film of higher conductivity is generally used for interconnection.

WO 97/48257, which has common applicants with the present application, the disclosure of which is incorporated herein, discloses an alternative method of forming an electrical circuit board, whereby a conducting ink is lithographically printed onto a substrate in order to form an electrical circuit. The ink comprises electrically conductive particles (such as metallic silver) suspended in an organic resin. The manufacture of electrical components such as resistors, capacitors and antennae is also described.

Although the circuit printing technique disclosed in WO 97/48257 is a significant improvement on previous techniques, it has a number of disadvantages.

First, it is advantageous to electroplate a second conducting layer onto the conductive ink disclosed in WO 97/48257 in order that electrical components can then be soldered on to the substrate and/or to reduce the resistivity of the circuit. The problem is that the ink does not adhere sufficiently well to the substrate to enable electroplating.

Second, in order to prepare a conductive ink, it is necessary to employ particulate conductive material with a particulate surface treatment (e.g. a coating of a long chain fatty acid) to enable the particles to be dispersed in the resin in such a manner as to render the dried ink electrically conductive. However, this surface treatment precludes further treatment of the dried ink, for example it prevents deposition of a further conductive layer by electroless deposition.

Third, it is difficult to solder electrical components onto an electrical circuit formed from conductive ink layers, because the layers do not contain sufficiently a high metal loading to create a suitable solder join. This means that components must be affixed using conductive polymer adhesive or a mechanical joint. However, it is thought that these joining methods do not age as well as solder, and exhibit higher electrical resistance. Moreover, any increase in the content of conductive particles in the ink is to the detriment of the ink's Theological properties.

WO 00/33625, which has common applicants with the present application, the disclosure of which is incorporated herein, discloses a process for depositing lithographic printing ink comprising depositing a metallic silver nano-particulate on a flexible substrate media by lithographic printing in order to form a plating seeding layer.

Although not disclosed in WO 00/33625, post-processing of the printed ink layers may optionally take place. This involves immersing the printed ink films in a palladium solution to improve the homogeneity of the final plating deposit, followed by copper plating via conventional electroless and electroplating processes.

The resulting circuit tracks consist of a silver ink base layer surmounted by a copper metal deposit. Conductive tracks formed by the silver-seeding process possess a bulk resistivity substantially closer to that of copper metal. The silver-seeding process is, however, generally a three-stage process, requiring separate printing, palladium activation and copper plating operations. The speed of circuit production is therefore potentially reduced.

Another problem is that the process of WO 00/33625—whilst moderately effective—employs as the principal ink constituent a silver metal nano-particulate with a mean particle size of 0.1 μm (1×10⁻⁷ m). This silver particulate is costly (currently about £200/kilogram) and is difficult to manufacture. There is a further cost disadvantage in the use of a conventional palladium bath.

U.S. Pat. No. 4,756,756 (Rhone-Poulenc Specialities Chimiques) discloses the use of a silk-screening process to deposit a non-conductive metal oxide ink onto an insulating substrate, followed by the step of employing a reducing agent to convert the metal oxide to conducting metal. There is no disclosure of the use of a lithographic printing process.

GB 1,016,465 (Corning Glass Works) discloses coating a substrate with a metal oxide adherent film, reducing the metal oxide to a metal and then depositing further metal coating thereon. There is no disclosure of any printing step.

GB 2,027,270 (philips) discloses a screen-printing ink which comprises a reducible metal oxide. However, the metal oxide is reduced to a lower oxide rather than to a metal and is used as an oxidising agent to eliminate the organic binder by oxidation.

U.S. Pat. No. 6,379,569 (Saint-Gobain Vitrage) discloses process for chemically etching an electrically conductive layer on a transparent glass substrate, in which a hot-melt ink is deposited on the substrate to form a mask.

U.S. Pat. No. 3,873,360 (Western Electric Company, Inc.) relates to a process in which metal ions in solution are coated onto a polyimide sheet and then a delineated pattern of a reducing agent is printed onto the coated surface. The process appears to be a multi-stage Redox process that relies on sequential oxidation/reduction of metal oxide particles in aqueous suspension. There is no apparent use of an oil-based ink/water system to deposit oxide particles.

According to a first aspect of the present invention, there is provided a process for forming a conductive layer on a substrate (preferably a flexible substrate), comprising the steps of providing an ink comprising a metal oxide in particulate form suspended in a mixture of a resin and an organic solvent, depositing the ink on a substrate by means of a lithographic printing process, and applying a reducing agent to the ink to reduce at least some of said metal oxide to metal.

The metal oxide layer may be conductive or non-conductive. Preferably, the metal oxide is copper (II) oxide.

When a powder is incorporated into an ink vehicle, the vehicle components must be selected and adjusted to create a mixture with the correct viscosity and rheological properties to pass through a lithographic press, and subsequently adhere to a substrate. It has not previously been thought possible to prepare a metal oxide ink that could be (a) lithographically printed and (b) prepared in a resin vehicle which, when cured, would allow a reducing agent in solution to act on the oxide particles sufficiently to reduce them to form a conductive seeding layer. One foreseen difficulty was that lithographic ink vehicles have to be resin based, and it was thought that the hydrophobic resin vehicle would effectively repel a reducing agent in aqueous solution, thus preventing adequate wetting of the ink particulate during the subsequent chemical reduction phase. Moreover, it was thought that a reducing agent dissolved in an organic solvent (if this could be formulated) would dissolve the resin and hence destroy the printed image.

A further potential difficulty concerned the hydrophilic (water attracting) characteristics of certain metal oxide powders, which could result in the ink particulate migrating into the fount solution of the lithographic printing press.

Surprisingly, it has been found that a metal oxide ink can be lithographically printed onto a substrate in accordance with the present invention.

A further problem is that it has been found that certain resins are adversely affected by certain reducing agents and/or electroless or electroplating processes. In particular, the inks which are found to have been affected are those which employ an alkyd resin (the preferred resin of WO 97/48257 and WO 00/33625) as the sole resin base. The adhesion of these inks to substrates such as the Polyart substrate (a coated polyethylene material) has been found to be degraded by the action of a reducing agents or the subsequent electroless/electroplating step.

Further work is being carried out to establish exactly what causes this problem, but in the meantime there is clearly a need for a lithographic resin vehicle which:

is resistant to acid solutions

does not degrade

allows a degree of wetting by a reducing agent

is compatible with strong reducing agents

can be lithographically printed

is preferably thixotropic in its rheology (that is with a viscosity in the range 10³ mPaS @ 25 degrees C. to 10⁵ mPaS @ 25° C.)

According to a second aspect of the present invention, there is provided an ink for use in a lithographic printing process onto a substrate (such as a polymer substrate), the ink comprising a metal oxide suspended in an ink vehicle, wherein said vehicle comprises a at least one resin and an organic solvent. The ink vehicle preferably comprises at least one alkyd resin and at least one non-alkyd resin. An anti-oxidant such as eugenol may also be added to the ink formulation.

The ink preferably comprises from 65 to 82% (more preferably about 75%) by weight of metal oxide in particulate form, with the remainder comprising the ink vehicle. The ink vehicle preferably comprises from 75 to 85% (more preferably about 80%) w/w resin, from 15 to 25% (more preferably about 20%) w/w organic solvent, and (optionally) from 1 to 2% (more preferably about 1.5%) w/w of an anti-oxidant such as eugenol.

In a preferred embodiment, the resin comprises a mixture of an alkyd resin and a resin which is not an alkyd resin. The amount of alkyd resin as a proportion of the total resin content is preferably from 65 to 95% w/w, more preferably from 75 to 85% w/w, most preferably about 80% w/w. The amount of non-alkyd resin as a proportion of the total resin content of the ink vehicle is preferably from 5 to 35% w/w, more preferably from 15 to 25% w/w, most preferably about 20% w/w.

The alkyd resin may be any conventional alkyd resin. A particularly preferred example is the alkyd resin sold under trade mark VX1598 by Lawtor.

The non-alkyd resin may be a polymer blended with various oils. Preferably, the resin comprises a polymer having amide groups, for example a nylon-based polymer.

One resin which has been found to be particularly suitable is available commercially Lawter International (of Ketenislaan 1c-Haven 1520, B-9130 Kallow, Belgium) under the trade name “Nypol 3”. Nypol 3 comprises a modified polyamide and tung oil and vegetable oil blends.

The term “lithographic printing” referred to herein is a printing process which utilizes differences in surface chemistry of the printing plate, including hydrophilic and hydrophobic properties. It does not refer to the commonly used process involving photoresist and etching occurring during the production of etched circuit boards and/or silicon semiconductor micro electronics. The term “ink” is intended to mean any material suitable for printing.

Preferably, the ink is applied to the substrate by means of offset lithography. The layer of at least partially oxidised ink may then be electrolessed and/or electroplated in order to form, for example, flexible wiring board conductors and to achieve the desired conductor thickness.

Electroless deposition (or plating) is a well-known technique which involves coating an object (or part of an object) by means of a chemical reduction process, which, once initiated, is auto-catalytic. The process is similar to electroplating except that no external current is required. In order to plate an object electrolessly, a seeding layer of suitable geometry and electrical and chemical characteristics must be formed on the object in order to provide nucleation sites for the metal to be deposited. It is thought that the seeding layer acts as a catalyst, in that it reduces the activation energy for the deposition step.

The preferred plating seeding manufacturing technique is a two-stage process, incorporating the following steps:

1. An initial stage employing either offset lithography or a related printing technology to deposit ink layers containing a metal oxide based printing ink onto flexible substrates. Nano-particulate metallic powders or precious metals are not employed in the ink, and hence the disclosed process is considerably cheaper than the described prior-art process. The particle size of the metal oxide is considerable larger than the particulate in process disclosed in WO 00/33625, which further reduces the cost of manufacturing the raw ink materials and hence the overall cost of the process.

2. A second stage comprising a chemical reduction process, which converts the metal oxide in the dried ink films (in whole or in part) to metal, thereby forming the plating seeding layer.

The resulting metal/metal oxide seeding layer may then be electrolessed and/or electroplated to form flexible wiring board conductors and to achieve the desired conductor thickness.

According to a third aspect of the present invention, there is provided a substrate having an ink layer printed thereon, wherein the ink layer has been formed by means of a process as defined above.

Applications

Particular applications of “metal oxide seeding ink” are in manufacturing flexible wiring boards for electronic circuits and systems, in manufacturing keyboard switch membranes, in security tagging structures and related artefacts. Further application are radio-frequency and/or microwave stripline components and antennae, flexible sensor structures and printed electronic components.

The Ink

Ink layers deposited by the lithographic and related printing processes are about 3-5 microns (3-5×10⁻⁶ m) thick. The ink must therefore exhibit a sufficiently high proportion of a suitable metal oxide and yet conform to the mechanical constraints imposed by the lithographic or related printing processes.

The adopted approach has been to formulate inks from metal oxides whose particles are suspended in a compounded organic resin vehicle. The vehicle largely determines the mechanical properties of the ink. Manipulation of the vehicle formulation, and the inclusion of various rheology modifiers and solvents permits the mechanical properties of the ink (e.g. viscosity), to be adjusted in relative isolation of its metal oxide loading. The ink formulations can be deposited by standard lithographic and related printing processes. Copper (II) oxide with a mean particle size of approximately 400 nanometers (400×10⁻⁹ m) has been successfully employed as the ink particulate.

When printed, the resulting ink films consist of a “pebble dash” of metal oxide particles bound to the substrate surface by the ink vehicle. A typical plating ink formulation consists of:

Copper (II) oxide in fine powder with a mean particle size of 400 nanometers (400×10⁻⁹ m) 75% w/w for lithography.

An ink vehicle 25% w/w for lithography, comprising: An alkyd or polymer resin—such as Lawtor VX1578, or Nypol 3 (79.5% w.w). A hydrocarbon fraction—such as Exxon M71A (19% w/w). An anti-oxidant—such as Eugenol (1.5% w/w).

The ink is mixed and characterised according to standard practices or printing ink manufacture. Ink films printed from the above described formulation can be converted by chemical reduction (in whole or in part) to form a copper metal plating seeding layer, which can subsequently be plated to any desired metal thickness by established electroless and/or electroplating technologies.

The characteristics of the deposited plating ink films, and the resulting plating seeding layers and plated deposits are affected by:

Metal oxide particle size and shape.

Particle to resin ratio of the formulated ink.

Ink Film Thickness.

The Substrate

The lithographic and related printing processes require the substrate to have a degree of affinity toward the plating ink. Flat bed lithographic printers can be employed for non-flexible substrates. Substrate considerations for successful circuit board fabrication include:

Substrate surface topography

Material properties.

Substrate topography will influence the quantity of ink laid down and the proximity of the particles of metal oxide. Following chemical reduction to metal, the substrate topography will also influence the ability of the ink films to be electroless or electroplated into a cohesive electrically conducting metal layer. A reasonably smooth surface is preferable, although this has been shown to be detrimental to the rub resistance of the printed ink films.

However, if a primer is used (such as EVA) then surface topography is not so much of an issue.

The material properties of the substrate that must be considered include moisture resistance, dielectric properties, flame retardancy, temperature cycling and mechanical strength. Gloss art paper, sheet polymers and a semi-synthetic (polyester fibre) paper have been successfully employed in printing trials.

The substrate onto which the conductive layer is printed is preferably formed from a polymer, and preferably comprises a flexible sheet. Suitable polymers include polyethylene, polypropylene, a polyester, a polyamide, a polyimide or a polysulphone. The substrate may be treated to improve adhesion of the ink to the substrate surface. For example, the substrate may be coated with a copolymer adhesive layer, or the surface may be chemically treated or subjected to corona treatment.

Preferably, the substrate is formed from a polyester, polyethylene, polypropylene or a polyamide, with or without a copolymer adhesive layer. In a particularly preferred embodiment, the substrate is a copolymer coated polyester, such as that available commercially from GBC (UK) Ltd of Rutherford Road, Basingstoke, Hampshire, RG24 8PD.

Chemical Reducing Agent

A chemical reducing agent, containing for example sodium borohydride NaBH₄, sodium hypoborate NaH₂PO₂, or dimethylamine borane (DMAB) C₂H₁₀BN, alone or in combination with pH modifiers and other materials. The reduction process is preferably carried out under alkaline conditions and aqueous sodium hydroxide preferably used as the pH modifier. The function of the reducing agent is to chemically reduce the metal oxide particulate in the deposited plating ink (in whole or in part) to metal, rendering the ink film a plating seeding layer, and capable of electroless and/or electroplating by conventional chemical plating processes.

A number of preferred examples of the present invention will now be described with reference to the accompanying figures, in which:

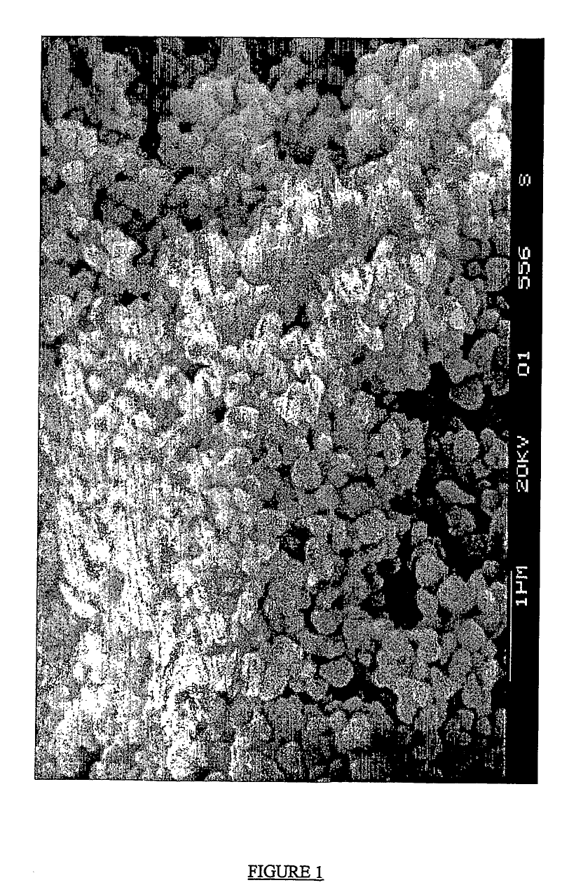

FIG. 1 depicts a micrograph of a copper (II) oxide ink film deposited in accordance with the invention; and

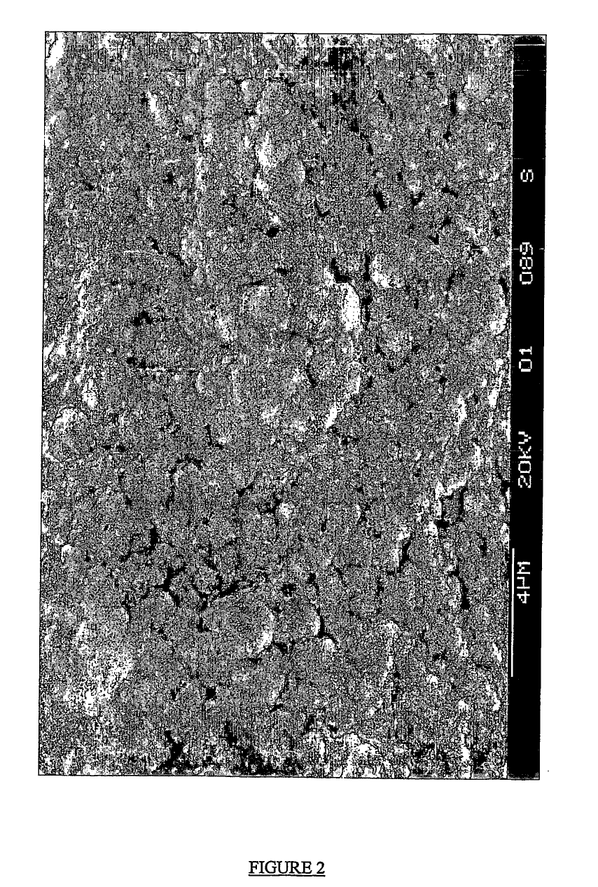

FIG. 2 depicts a micrograph of a copper plated seeding layer formed in accordance with the invention.

### EXAMPLE

A range of prototype ink formulations incorporating copper (II) oxide were developed and a series of comparative printing trials resulted in several ink formulations with acceptable rheology, metal oxide loading and drying properties. The developed inks consist of a high proportion (77-82% w/v) of copper (II) oxide with a mean particle size of 400 nm suspended in an organic resin vehicle with solvents and rheology modifiers.

An exemplary ink is:

75% w/w copper (II) oxide in fine powder with a mean particle size of 400 nanometers (400×10⁻⁹ m).

25% w/w ink vehicle, comprising:

79.5% w/w Lawtor VX1578 (alkyd resin)

19% w/w Exxon M71A (organic solvent)

1.5% w/w Eugenol (anti-oxidant).

Printing trials employing these prototype inks were conducted on polyethylene, unclad FR4, Kapton and coated polypropylene substrates. A micrograph of printed metal oxide ink film is depicted in FIG. 1. The printed substrates were employed in a series of trials to evaluate prototype chemical reducing solutions on the dried copper (II) oxide ink films.

Reducing Agent Trials

Trials of several chemical reducing agents in conjunction with printed copper (II) oxide ink films were conducted. The objective was to develop an economic reducing bath formation that rapidly converted a proportion of the copper (II) oxide particulate in the dried ink films to metal, without damage to either the ink binder or substrate material. Compounds evaluated in these trials included sodium borohydride NaBH₄, sodium hypophosphite NaH₂PO₂ and dimethylamine borane (DMAB) C₂H₁₀BN in combination with solvents and pH modifies.

Optimal results were obtained using an alkaline DMAB solution, which substantially reduced the surface of the printed ink films within 2 min at 25° C. The chemically reduced ink films were found to exhibit excellent plating seeding characteristics, being capable of electroless and/or electroplating by various conventional chemical plating processes.

Copper Plating Trials

Samples of the chemically reduced substrates were copper plated using a conventional electroless copper plating process (Shipley “Circuposit 4750” electroless copper). The electroless plating time was varied between three and 30 min, resulting in copper deposits ranging in thickness between 0.5 and 2 microns (10⁻⁶ m).

The plating deposit is clearly visible in FIG. 2, which is a micrograph of a chemically reduced and electroless plated copper (II) oxide ink film. The copper plating deposit is the dark material surrounding and interconnecting the lighter copper (II) oxide granules. The physical appearance of the deposit is well defined and consistent, and possesses a high degree of adhesion to the substrate material.

Following electroless plating, samples of the ink films were electroplated using a conventional copper (II) sulphate/sulphuric acid plating process with a current density of 1 A/dm² until a copper metal deposit exceeding 10 μm in thickness had been obtained.

Results

The electroless and electroplated samples of copper (II) oxide ink films were examined by electron microscopy, which revealed a uniform and consistent layer of copper metal bonded to the underlying substrate material. Minimal “spreading” of fine line structures was observed. In common with other CLF circuit fabrication strategies, the degree of adhesion of the circuit track structures to the substrate was observed to be dependent on substrate material (substrate topography).

Measurement of the resistance of elongated circuit tracks plated with approximately 1 micron of electroless copper and 10 microns of electroplated copper metal, indicate sheet resistances of the order of 20 mΩ/□. These conductors are capable of further electroplating to reduce this sheet resistance to that approximating copper metal.

1.-11. canceled

12. A process for forming a conductive layer on a substrate, comprising the steps of:
a. providing an ink comprising a metal oxide in particulate form suspended in a mixture of a resin and an organic solvent,
b. depositing the ink on a substrate by means of a lithographic printing process, and
c. applying a reducing agent to the ink to reduce at least some of said metal oxide to metal,
wherein said resin is a mixture of an alkyd resin and a non-alkyd resin.

13. A process as claimed in claim 12, depositing an electrically conducting layer on said metal by electroless deposition.

14. A process as claimed in claim 12, additionally comprising the step of electroplating an electrically conducting layer onto said metal.

15. A process as claimed in claim 13, additionally comprising the step of electroplating a further electrically conducting layer onto said electrolessed electrically conducting layer.

16. A process as claimed in claim 12, wherein the non-alkyd resin comprises a polymer having amide groups.

17. A process as claimed in claim 16, wherein the non-alkyd resin comprises a nylon-based polymer.

18. An electrical device comprising a substrate having an electrical circuit printed thereon by a process as claimed in claim 12.

19. An ink for use in a lithographic printing process onto a substrate, the ink comprising a metal oxide suspended in an ink vehicle, said vehicle comprising a mixture of an alkyd resin and a non-alkyd resin and an organic solvent.

20. An ink as claimed in claim 19, wherein the non-alkyd resin comprises a polymer having amide groups.

21. An ink as claimed in claim 20, wherein the non-alkyd resin comprises a nylon-based polymer.
